(19) United States
(12) Patent Application Publication
(10) Pub. No.: US 2009/0073294 A1
(43) Pub. Date: Mar. 19, 2009

(54) Solid-state image capturing apparatus and electronic information device

(76) Inventor: Hidenori Morimoto, Nara (JP)

Correspondence Address: Edwards Angell Palmer & Dodge LLP, P.O. Box 55874, Boston, MA, 02205, US

(21) Appl. No.: 12/230,480

(22) Filed: Aug. 29, 2008

(30) Foreign Application Priority Data
Aug. 30, 2007 (JP) 2007-224568

(51) Int. Cl. H04N 5/335

(52) U.S. Cl. 348/300; 348/294; 348/E05.091

(57) ABSTRACT

A solid-state image capturing apparatus comprises a pixel array in which pixel sections for outputting a pixel signal in accordance with incident light are arranged in two dimensions, and a readout signal line arranged for each pixel section column on the pixel array, for reading out a pixel signal from each pixel section in each pixel section column, where each pixel section includes a light receiving section for performing photoelectric conversion on incident light; a signal charge storing section for storing a signal charge generated in the light receiving section and generating electric potential in accordance with the stored signal charge; and a reset transistor for resetting electric potential of the signal charge storing section to reset electric potential.

This Nonprovisional application claims priority under 35 U.S.C. §119(a) on Patent Application No. 2007-224568 filed in Japan on Aug. 30, 2007, the entire contents of which are hereby incorporated by reference.

### BACKGROUND OF THE INVENTION

1. Field of the Invention

The present invention relates to a solid-state image capturing apparatus and an electronic information device, and more particularly, to an amplifying solid-state image capturing apparatus with an improved performance, in which a pixel section includes an amplifying circuit, and an electronic information device using such an amplifying solid-state image capturing apparatus.

2. Description of the Related Art

In general, an amplifying solid-state image capturing apparatus includes a pixel array section, in which pixel sections (also referred simply to as a pixel, herein after) having an amplifying function are arranged in two dimension, and a scanning circuit positioned in the periphery of the pixel array section. An amplifying solid-state image capturing apparatus with such a scanning circuit for reading out pixel data from each pixel is in wide use.

As one example of the amplifying solid-state image capturing apparatus, an APS (Active Pixel Sensor) image sensor, which is constituted of a CMOS circuit, is generally known, the CMOS circuit being advantageous for the pixel to be combined with a driving circuit and a signal processing circuit in the periphery. Further, among the APS image sensors, a four transistor-type APS image sensor, which is capable of obtaining a high picture quality, is becoming the mainstream.

FIG. 6 is a diagram illustrating a conventional four transistor-type, amplifying solid-state image capturing apparatus, showing a circuit structure of each pixel section (unit pixel) that constitutes the solid-state image capturing apparatus.

As shown in FIG. 6, a pixel section 110, which constitutes the conventional amplifying solid-state image capturing apparatus, is constituted of a light receiving section 101 for converting light into electron, a transfer transistor 102 for transferring a signal charge generated in the light receiving section 101 to a signal charge storing section (charge storing section) 103, an amplifying transistor 105 for amplifying the signal charge transferred to the signal charge storing section 103 to generate a corresponding signal voltage, a reset transistor 104 for resetting the signal charge storing section 103, or a gate of the amplifying transistor 105, to power source voltage Vd, and a selection transistor 106 for transferring an output of the amplifying transistor 105 to a readout signal line 107. In the solid-state image capturing apparatus described above, a plurality of pixels having such a configuration are arranged in two dimensions, or in a matrix state. The readout signal line 107 described above is provided for each pixel column, and each selection transistor for a pixel in each pixel column is all connected to the corresponding readout signal line 107. In addition, each readout signal line 107 is connected to each corresponding constant current source load 111. The constant current source load 111 is constituted of a transistor connected between one end of the readout signal line 107 and a ground, and a gate of the transistor is set to a constant voltage Vc.

Herein, the light receiving section 101 is generally constituted of an embedded photodiode. In addition, the transfer transistor 102 described above is connected between the signal charge storing section 103 for storing a signal charge from the light receiving section 101 and a cathode of the photodiode, and the gate of the transfer transistor 102 is connected to a transfer gate selection line 123. The transfer transistor 102 turns on when a voltage level (transfer control signal) TX of the transfer gate selection line 123 is at a high level, and the transfer transistor 102 transfers a signal charge generated in the photodiode to the signal charge storing section 103. Note that the signal charge storing section 103 is also referred to as floating diffusion section (FD section).

In addition, the reset transistor 104 described above is connected between the signal charge storing section 103 and the voltage source (power source voltage Vd), and the gate of the reset transistor 104 is connected to a reset signal line 122. The reset transistor 104 turns on when a voltage level (reset signal) RST of the reset signal line 122 is at a high level, and the reset transistor 104 resets an electric potential of the signal charge storing section 103 to the power source voltage Vd. Further, the amplifying transistor 105 and the selection transistor 106 are connected in series between the voltage source (power source voltage Vd) and the readout signal line 107. A gate on the voltage source side of the amplifying transistor 105 is connected to the signal charge storing section 103, and a gate on the readout signal line side of the selection transistor 106 is connected to a selection signal line 121. The selection transistor 106 turns on when a voltage level (selection signal) SEL of the selection signal line is at a high level, and selects a pixel so that corresponding signal voltage of the pixel is read out to the readout signal line 107.

Next, an operation will be described.

In the light receiving section 101, a signal charge is generated by photoelectric conversion of incident light. The signal charge generated in the light receiving section 101 is transferred to the signal charge storing section (FD section) 103 by the transfer transistor 102. The signal charge storing section 103 is reset to the power source voltage Vd by the reset transistor 104. Therefore, respective electric potentials of the signal charge storing section 103 after the resetting and after the transferring of the signal charge are amplified by the amplifying transistor 105, and are read out to the readout signal line 107 via the selection transistor 106. At this stage, current is supplied to the readout signal line 107 from the pixel 110 in accordance with the electric potential of the signal charge storing section 103. The supplied current is drained to the ground side via the constant current source load 111. As a result, a readout voltage is generated in the readout signal line 107 in accordance with current supplied from the pixel section 110, and the readout voltage is outputted to a circuit in a later stage so as to obtain pixel data of each pixel.

When a miniaturization of a pixel pitch advances from 2.2 μm to 1.75 μm in such a CMOS image sensor, problems such as a decrease of the amount of signal charges due to the reduction of a photoelectric conversion element, an increase of noise due to the miniaturization of the amplifying MOS transistor, and the like occur. Therefore, it is effective to reduce the number of the transistors and reduce the area taken by the transistors in order to increase the size of the photoelectric conversion element, rather than the miniaturization of the size of the transistors. As a method to achieve such matter, a three transistor-type pixel structure (3TR structure), in which a photoelectric conversion element and three transistors constitute a unit pixel, is proposed.

FIG. 7 is a diagram illustrating a unit pixel (also referred to simply as a pixel section herein after) having a 3TR structure, showing a circuit structure of two unit pixels connected to one readout signal line.

For example, a pixel section 210 with a 3TR structure is constituted of a light receiving section 201 which is formed by a photodiode, a transfer gate transistor 202 for transferring a signal charge generated in the light receiving section 201 to a signal charge storing section 203, a reset transistor 204 connected between the signal charge storing section 203 and a reset drain wiring 225, and an amplifying transistor 205 connected between a voltage source (power source voltage Vd) and a readout signal line 207.

Herein, a transfer gate selection line 223 is connected to a gate of the transfer transistor 202 described above, and the transfer transistor 202 receives a transfer pulse signal TX0 from the transfer gate selection line 223 to transfer a signal charge generated in the light receiving section 201 to the signal charge storing section 203. In addition, a reset signal line 222 is connected to a gate of the reset transistor 204, and the reset transistor 204 applies voltage Vr0 of the reset drain wiring 225 to the signal charge storing section 203 by a reset signal RST0 from the reset signal line 222.

In addition, a pixel section 250 with a 3TR structure is constituted, in a similar manner to the pixel section 210 with a 3TR structure, a light receiving section 251 formed of a photodiode, the light receiving section generating a signal charge by photoelectric conversion, a transfer gate transistor 252 for transferring the signal charge to a signal charge storing section 253 based on a transfer pulse signal TX1 from a transfer gate selection line 273, a reset transistor 254 for applying voltage Vr1 of a reset drain wiring 275 to the signal charge storing section 253 based on a reset signal RST1 from a reset signal line 272, and an amplifying transistor 255 for amplifying signal voltage generated in the signal charge storing section 253 or reset voltage to output the signal voltage or the reset voltage to the readout signal line 207.

The pixel section 210 and pixel section 250 are connected to the readout signal line 207 together with other pixel sections in the same column, and the readout signal line 207 is connected to a constant current source load 211. The constant current source load 211 is constituted of a transistor connected between one end of the readout signal line 207 and a ground, and a gate voltage of the transistor is set to a constant voltage Vc.

The unit pixels (pixel sections) 210 and 250 with a 3TR structure are different from a unit pixel of a 4TR structure. As shown in FIG. 7, the unit pixels 210 and 250 are not provided with a transistor, which corresponds to a selection transistor connected in series to the amplifying transistor 105 in FIG. 6. Therefore, in a 3TR structure, a pixel selecting operation for selecting a predetermined pixel from multiple pixels connected to the readout signal line 207 is performed not by a selection transistor of a 4TR structure but by controlling electric potentials of the FD sections 203 and 253, which are signal charge storing sections.

Next, an operation will be described.

In a CMOS image sensor with a 3TR structure, the transfer gate selection lines 223 and 273, the reset signal lines 222 and 272, and the reset drain wirings 225 and 275 are controlled, so that voltage of the FD sections 203 and 253 in each pixel section is changed, and accordingly, voltage of the readout signal line 207 is also changed.

For example, when the pixel section 210 is selected, signal levels Vr0 and Vr1 of the reset drain lines 225 and 275 are turned to a low level electric potential (VL) and subsequently, signal levels RST0 and RST1 of the reset gate wirings 222 and 272 are raised, and electric potential of the FD sections 203 and 253 is turned to a low level (low reset).

Next, the constant current source load 211 of the readout signal line 207, which corresponds to a pixel column that includes the pixel section 210, is operated by raising gate controlling voltage Vc of the transistor 211, the transistor 211 constituting the constant current source load 211. Subsequently, electric potential Vr0 of the reset drain wiring 225, which is connected to the selected pixel section 210, is turned to a high level, so that only electric potential VD0 of the FD section 203 in the selected pixel section 210 is tuned to a high level (high reset). At this time, voltage (VFD) of the FD section 203 is:

VFD=Vd−Vth (equation 1)

Herein, Vd denotes power source voltage, Vth denotes threshold voltage of the reset transistor 204. As described above, the voltage VFD of the FD section 203 is lower than the power source voltage Vd, and it is disadvantageous to complete a signal charge transfer. As a measure for this, a transistor with a low threshold voltage or a depletion-type transistor can be used as the reset transistor 204 so that voltage of the FD section 203 at the time of high reset can be increased as high as power source voltage.

Subsequently, when the signal levels RST0 of the reset gate wiring 222 in the selected pixel section 210 is lowered, the electric potential FD0 of the FD section 203 is lowered by coupling capacitance C1 between the gate of the reset transistor 204 and the FD section 203. In addition, because the change in the electric potential FD0 appears in the readout signal line 207 via the amplifying transistor 205, voltage Vout of the readout signal line 207 is also lowered, and further, voltage VD0 of the FD section 203 is lowered by coupling capacitance C2 between the readout signal line 207 and the gate of the amplifying transistor 205.

Due to the effect of coupling of the capacitance, electric potential of the FD section 203 becomes lower than the power source voltage Vd. The signal line voltage (reset level) Vout, which corresponds to the voltage of the FD section 203, is introduced into a circuit (not shown) in the next stage, which is connected to the readout signal line 207.

Subsequently, when the transfer gate pulse TX0 is applied to the transfer gate transistor 202, a signal charge is transferred from the light receiving section 201 to the FD section 203, and electric potential of the FD section 203 is lowered. Simultaneously, voltage level Vout of the readout signal line 207 is also lowered. The voltage level Vout of the readout signal line 207 is introduced into the circuit in the next stage as a signal level. The circuit in the next stage takes the difference between the reset level and the signal level, and outputs the difference voltage as a pixel signal of the selected pixel section 210.

After the signal level RST0 of the reset gate wiring 222 becomes a high level and electric potential VD0 of the FD section 203 becomes a high level, a signal level of the reset drain wiring 225 becomes a low level, and electric potential of the FD section 203 becomes a low level. Subsequently, the transistor 211 is turned off, the transistor constituting a constant current source load of the readout signal line 207, which is connected to the pixel section 210.

During readout of a pixel signal from such a selected pixel section, the voltage level Vr1 of the reset drain wiring 275 in a non-selected pixel section 250 is at a low level, and the signal level RST1 of the reset signal line 272 is at a high level. Therefore, electric potential of the FD section 253 in the non-selected pixel section 250 is fixed to a low level. Even if electric potential of the readout signal line 207 changes, electric potential of the FD section 253 will not change.

For example, such an amplifying solid-state image capturing apparatus with a 3TR structure is disclosed in Reference 1.

International Publication WO 2003/069897 pamphlet

### SUMMARY OF THE INVENTION

As described above, in the conventional amplifying solid-state image capturing apparatus with a 3TR structure, the voltage level Vr1 of the reset drain wiring 275 in a non-selected pixel section 250 is at a low level, and the signal level RST1 of the reset signal line 272 is at a high level, and therefore, electric potential of the FD section 253 in the non-selected pixel section 250 is fixed to a low level. However, as shown in FIG. 7, electric potential of the FD section 253 in the non-selected pixel section 250 actually changes in accordance with the change of electric potential of a readout signal line 207 by the coupling capacitance C2 of the FD section 253 and the readout signal line 207. As a result, the electric potential of the reset drain wiring 275 fluctuates, and this change in the electric potential of the reset drain 275 becomes a noise source for the selected pixel section 210.

The present invention is intended to solve the conventional problems described above. The objective of the present invention is to provide a solid-state image capturing apparatus, which is capable of reducing the effect of the change in electric potential of a reset drain wiring that is affecting as noise to an adjacent, selected pixel section connected to another reset drain wiring, and of improving S/N ratio. The objective of the present invention is further to provide an electronic information device using the solid-state image capturing apparatus.

A solid-state image capturing apparatus according to the present invention includes a pixel array in which pixel sections for outputting a pixel signal in accordance with incident light are arranged in two dimensions, and a readout signal line arranged for each pixel section column on the pixel array, for reading out a pixel signal from each pixel section in each pixel section column, in which each pixel section includes a light receiving section for performing photoelectric conversion on the incident light; a signal charge storing section for storing a signal charge generated in the light receiving section and generating electric potential in accordance with the stored signal charge; and a reset transistor for resetting the electric potential of the signal charge storing section to reset electric potential, in which a reset drain wiring for supplying the reset electric potential to a drain of the reset transistor being positioned above a plurality of pixel sections in the pixel array in such a manner to cross the center of each pixel section, thereby achieving the objective described above.

Preferably, in a solid-state image capturing apparatus according to the present invention, a wiring layer, which constitutes the reset drain wiring, is formed by a second layer metal wiring of multiple layer wirings that are laminated with alternately interposed insulation films on the pixel array, and is connected to a drain region in the drain region of the reset transistor via a first layer metal wiring formed on the pixel array.

Still preferably, in a solid-state image capturing apparatus according to the present invention, the first layer metal wiring, which connects the drain region and the reset drain wiring constituted of the second layer metal wiring, in the drain region of the reset transistor is positioned only in the drain region so as to be located at the center of the pixel section.

Still preferably, in a solid-state image capturing apparatus according to the present invention, the light receiving section is constituted of two photodiodes positioned in an opposing manner on both sides of the signal charge storing section.

Still preferably, in a solid-state image capturing apparatus according to the present invention, the pixel section includes two transfer transistors for transferring the signal charge from each photodiode to the signal charge storing section, the two transfer transistors corresponding to the two photodiodes.

Still preferably, in a solid-state image capturing apparatus according to the present invention, the photodiode is an embedded photodiode.

Still preferably, in a solid-state image capturing apparatus according to the present invention, two diffusion regions, which constitute each of the photodiodes, are connected to a diffusion region, which is located in between the two diffusion regions and constitutes the signal charge storing section, and in which a gate electrode of each of the transfer transistors is positioned above a connecting portion between a diffusion region constituting the photodiode and a diffusion region constituting the signal charge storing section.

Still preferably, in a solid-state image capturing apparatus according to the present invention, the diffusion region constituting the photodiode is a rectangle; the diffusion region constituting the signal charge storing section is a longitudinally elongated rectangle; the gate electrode of each of the transfer transistors is positioned at a corner of the rectangular diffusion region that constitutes the photodiode, and is positioned diagonally to a side edge of the rectangle.

Still preferably, in a solid-state image capturing apparatus according to the present invention, the reset drain wiring is positioned in between two opposing photodiodes that constitute the pixel section.

Still preferably, in a solid-state image capturing apparatus according to the present invention, the pixel section includes one amplifying transistor for amplifying electric potential of the signal charge storing section to read out the electric potential to the readout signal line.

Still preferably, in a solid-state image capturing apparatus according to the present invention, a first voltage is applied to the reset drain wiring when the pixel section connected to the reset drain wiring is selected, and a second voltage is applied to the reset drain wiring when the pixel section connected to the reset drain is not selected, the first voltage being higher than or equal to the second voltage.

Still preferably, in a solid-state image capturing apparatus according to the present invention, the first voltage is higher than or equal to power source voltage, and the second voltage is higher than or equal to 0V.

Still preferably, in a solid-state image capturing apparatus according to the present invention, the light receiving section, which constitutes the pixel section, is constituted of a plurality of photoelectric conversion elements.

Still preferably, in a solid-state image capturing apparatus according to the present invention, the light receiving section, which constitutes the pixel section, is constituted of two or four photoelectric conversion elements.

Still preferably, in a solid-state image capturing apparatus according to the present invention, the solid-state image capturing apparatus includes a buffer circuit for applying the first voltage or the second voltage to the reset drain wiring.

Still preferably, in a solid-state image capturing apparatus according to the present invention, the buffer circuit is constituted of a CMOS inverter, which is constituted of a P-type MOS transistor and an N-type MOS transistor that are connected in series between a node, to which the first voltage is supplied, and a node, to which the second voltage is supplied.

Still preferably, a solid-state image capturing apparatus according to the present invention further includes a boost circuit for boosting the first voltage supplied to the buffer circuit more than power source voltage.

An electronic information device according to the present invention includes an image capturing section, in which any one of the solid-state image capturing apparatus according to the present invention is used for the image capturing section, thereby achieving the objective described above.

The functions of the present invention having the structures described above will be described herein after.

According to the present invention, in an amplifying solid-state image capturing apparatus that includes a pixel array having a plurality of pixel sections arranged in a matrix with each pixel section having a 3TR structure, a reset drain wiring is positioned above the pixel array in such a manner to cross the center of each pixel section. Therefore, it is possible to reduce the change in electric potential of a reset drain wiring affecting as noise to an adjacent, selected pixel section connected to another reset drain wiring, and as a result, it is possible to improve S/N ratio.

In addition, because the transfer transistor is formed at a corner of each photodiode region, the gate region of the transfer transistor can be formed diagonal to a side edge of a rectangular photodiode. As a result, the charge transferring efficiency can be improved.

In addition, according to the present invention, because the high level electric potential applied to the reset drain wiring is raised by the power source voltage, the transferring efficiency of the signal charge from the light receiving section to the charge storing section can be improved. Further, because the low level electric potential applied to the reset drain wiring is set to be higher than 0V, the back flow of the signal charge can be prevented from the charge storing section.

According to the present invention with the structure described above, it is possible to reduce the change in electric potential of a reset drain wiring affecting as noise to an adjacent, selected pixel section connected to another reset drain wiring, and therefore, S/N ratio can be improved.

These and other advantages of the present invention will become apparent to those skilled in the art upon reading and understanding the following detailed description with reference to the accompanying figures.

### BRIEF DESCRIPTION OF THE DRAWINGS

FIG. 1 is a diagram of an amplifying solid-state image capturing apparatus according to Embodiment 1 of the present invention, illustrating a layout of a transistor and a photodiode that constitute the amplifying solid-state image capturing apparatus.

FIG. 2 is a diagram of the amplifying solid-state image capturing apparatus according to Embodiment 1 of the present invention, illustrating a layout of a first layer metal wiring that constitutes the amplifying solid-state image capturing apparatus.

FIG. 3 is a diagram of the amplifying solid-state image capturing apparatus according to Embodiment 1 of the present invention, illustrating a layout of a second layer metal wiring that constitutes the amplifying solid-state image capturing apparatus.

FIG. 4 is a diagram of the amplifying solid-state image capturing apparatus according to Embodiment 1 of the present invention, illustrating a layout of a first layer metal wiring that is compared with the layout of the first layer metal wiring in the amplifying solid-state image capturing apparatus according to Embodiment 1.

FIG. 5 is a diagram illustrating an amplifying solid-state image capturing apparatus according to Embodiment 2 of the present invention, FIG. 5(a) illustrating a circuit configuration of a pixel section that constitutes the solid-state image capturing apparatus, and FIG. 5(b) illustrating a circuit configuration of a buffer that constitutes the solid-state image capturing apparatus.

FIG. 6 is a diagram of a conventional four transistor-type, amplifying solid-state image capturing apparatus, illustrating a circuit structure of a pixel section that constitutes the solid-state image capturing apparatus.

FIG. 7 is a diagram of a three transistor-type amplifying solid-state image capturing apparatus, illustrating a circuit structure of a pixel section that constitutes the solid-state image capturing apparatus.

FIG. 8 is a diagram illustrating the effect of the present invention. FIG. 8(a) illustrates a state where the change in electric potential of the signal charge storing section of a selected pixel affects the change in electric potential of the signal charge storing section of the non-selected pixel. FIG. 8(b) illustrates the effect of the change in electric potential of the reset drain wiring on the electric potential of the signal charge storing section in the selected pixel.

FIG. 9 is a block diagram illustrating an exemplary diagrammatic structure of an electronic information device using a solid-state image capturing apparatus of any of Embodiments 1 and 2 in an image capturing section, as Embodiment 3 of the present invention.

U0, U1, U2, U3 unit block
501, 502, 511, 512, 521, 522, 531, 532 transfer transistor
503, 513, 523, 533 reset transistor
504, 514, 524, 534 reset gate
506, 516, 526, 536 amplifying transistor
507, 517, 527, 537 amplifying gate
601-607, 611-617, 621-627, 631-637 first layer metal wiring
701-705, 711-715 second layer metal wiring
PD1, PD2 photodiode region

### DESCRIPTION OF THE PREFERRED EMBODIMENTS

Embodiments of the present invention will be described herein after.

### Embodiment 1

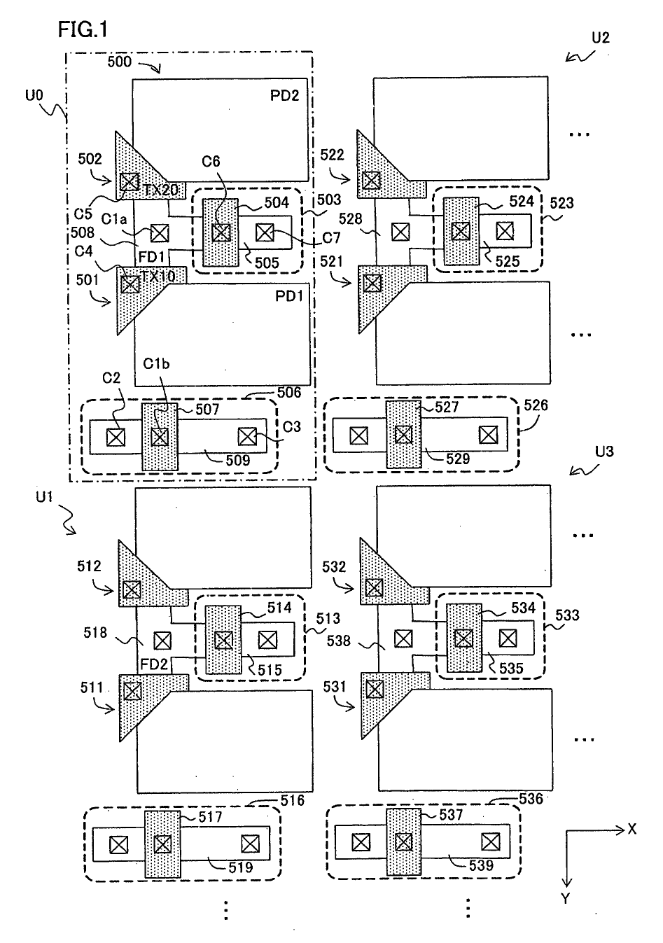

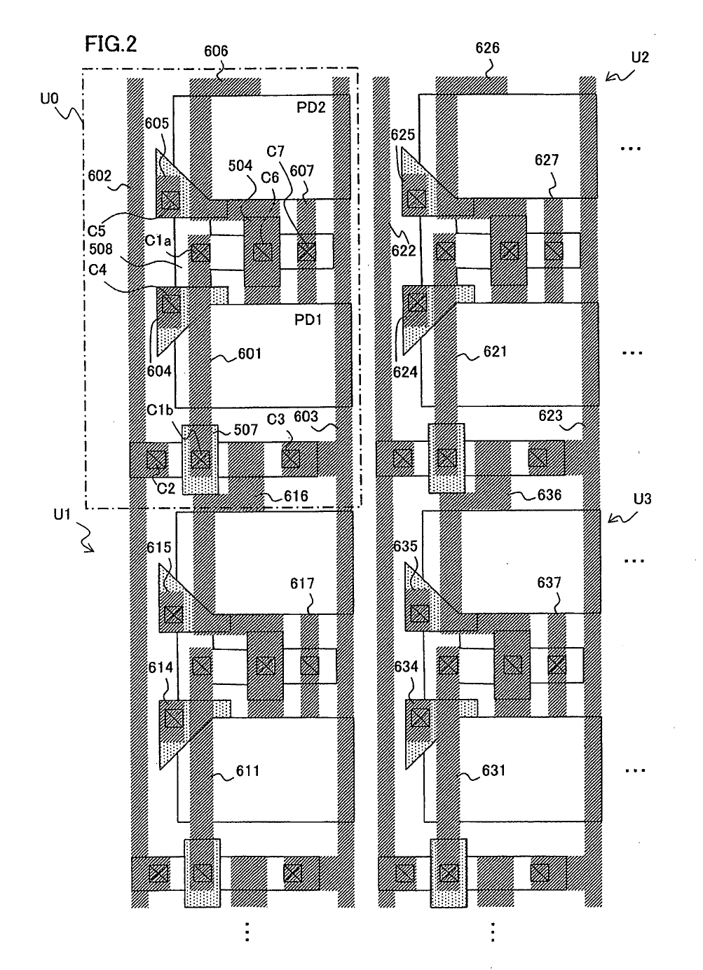

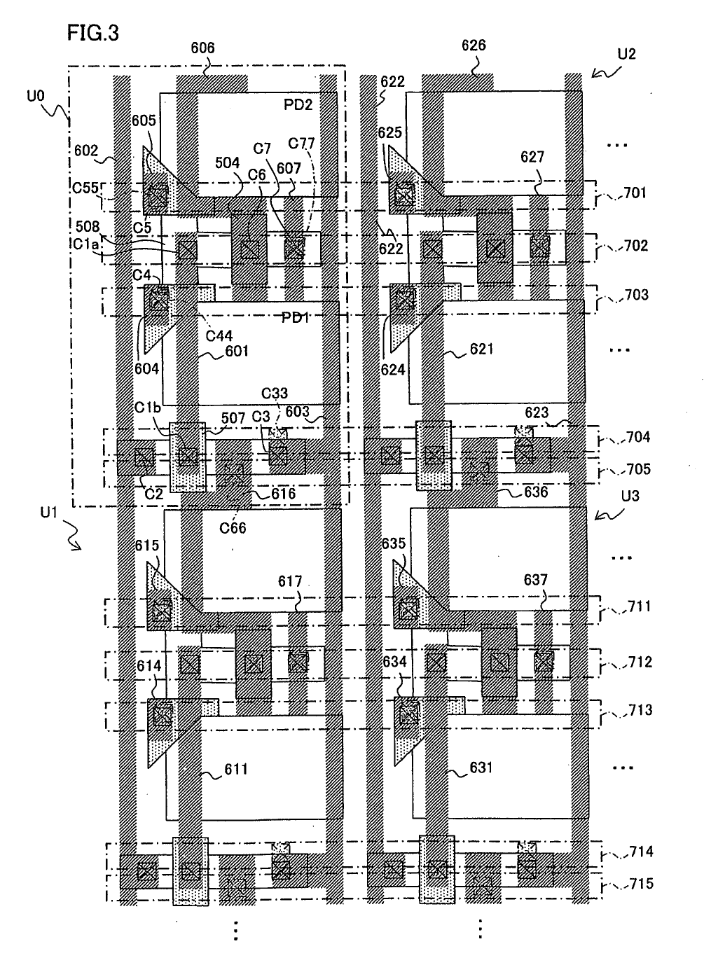

FIGS. 1 to 3 are diagrams illustrating an amplifying solid-state image capturing apparatus according to Embodiment 1 of the present invention. FIG. 1 is a layout of a transistor and a photodiode that constitute the amplifying solid-state image capturing apparatus. FIGS. 2 and 3 are layouts of a first layer metal wiring and a second layer metal wiring, respectively, that constitute the amplifying solid-state image capturing apparatus.

In the figures, an active pixel sensor with a two light-receiving element sharing structure, which shares two photoelectric conversion elements, namely photodiodes (light receiving elements), is illustrated as a layout of the amplifying solid-state image capturing apparatus.

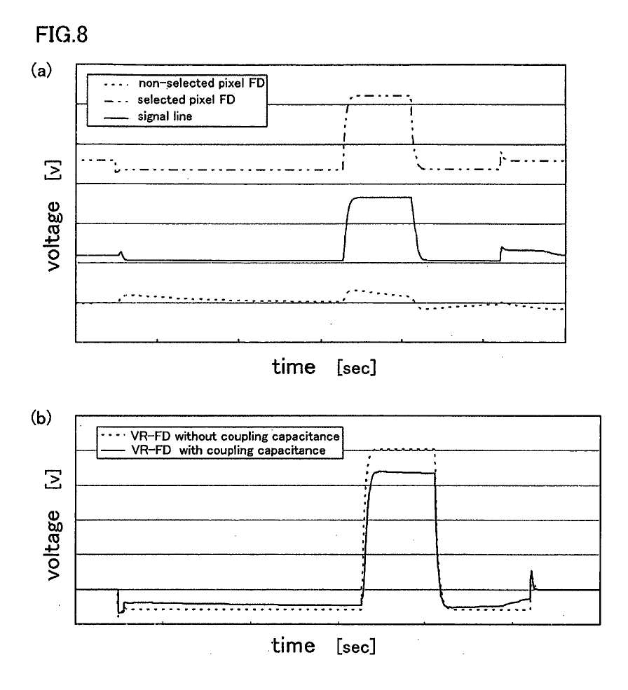

The amplifying solid-state image capturing apparatus according to Embodiment 1 has the same circuit configuration as that of the solid-state image capturing apparatus with a 3TR structure shown in FIG. 7.

Further, the solid-state image capturing apparatus according to Embodiment 1 has a sensor array 500, in which active pixel sensors with a two light-receiving element sharing structure are arranged as a unit block (pixel section) in a matrix on a surface of a substrate.

Herein, each unit block includes two photodiodes functioning as a light receiving section, two transfer gate transistors for transferring a signal charge generated in each photodiode to a signal charge storing section, one reset transistor for resetting the signal charge stored in the signal charge storing section, and one amplifying transistor for amplifying the signal charge stored in the signal charge storing section to be output to a readout signal line (vertical signal line).

Hereinafter, a unit block in the sensor array 500 will be described using the layout shown in FIG. 1.

For example, a unit block U0 includes two rectangular photodiode regions PD1 and PD2, transfer transistors 501 and 502 corresponding to respective photodiode regions, one reset transistor 503, and one amplifying transistor 506.

Herein, the two photodiode regions PD1 and PD2 are positioned to face each other along a first direction (column direction) Y. The reset transistor 503 is positioned in between the photodiode regions. Further, a longitudinally elongated diffusion region 508 is positioned at one end side between the photodiode regions, the longitudinally elongated diffusion region connected to both of the photodiode regions. A first transversely elongated diffusion region 505 is positioned at the center portion between the photodiode regions, the first transversely elongated diffusion region connected to the longitudinally elongated diffusion region 508.

A substantially right-triangular, transfer gate TX1 is positioned at a connecting portion between one end side of the longitudinally elongated diffusion region 508 and the first photodiode region PD1, in a manner such that the two edges forming the right angle are parallel to the longitudinal and transverse edges of the rectangular photodiode region PD1. A substantially right-triangular, transfer gate TX2 is positioned at a connecting portion between the other end side of the longitudinally elongated diffusion region 508 and the second photodiode region PD2, in a manner such that the two edges forming the right angle are parallel to the longitudinal and transverse sides of the rectangular photodiode region PD2. The center portion of the longitudinally elongated diffusion region 508 is a region shared by the source regions of the two transfer transistors described above and a signal charge storing section FD1. A drain region of each of the transfer transistors is included in the corresponding photodiode region.

Further, a reset gate 504 is positioned on the first transversely elongated diffusion region 505. Two side portions of both sides of the reset gate on the transversely elongated diffusion region 505 are a source region and a drain region of the reset transistor 503.

In addition, a second transversely elongated diffusion region 509 is positioned on one photodiode region PD1, on the opposing side of the positioning region of the reset transistor 503. An amplifying gate 507 (gate electrode of an amplifying transistor) is positioned on the second transversely elongated diffusion region 509. Both sides of the amplifying gate of the transversely elongated diffusion region 509 are a source region and a drain region of the amplifying transistor 506.

Contact holes C4 and C5 are positioned in the transfer gates TX10 and TX20 so as to be connected to the first layer metal wiring (see FIG. 2). Contact holes C6 and C1b are positioned on the reset gate 504 and the amplifying gate 507 so as to be connected to the first layer metal wiring (see FIG. 2). In addition, a contact hole C1a is positioned on the longitudinally elongated diffusion region 508 so as to be connected to the first layer metal wiring (see FIG. 2), the longitudinally elongated diffusion region 508 being shared by the signal charge storing section FD1, the source region of the transfer transistor, and the source region of the reset transistor. A contact hole C7 is positioned on the drain region of the reset transistor in the first transversely elongated diffusion region 505 so as to be connected to the first layer metal wiring (see FIG. 2). Further, contact holes C2 and C3 are positioned on the source region and the drain region of the amplifying transistor in the second transversely elongated diffusion region 509 so as to be connected to the first layer metal wiring (see FIG. 2).

Other unit blocks U1 to U3 have the same configuration as the unit block U0 described above.

That is, in the unit block U1, a first transfer transistor 511 is positioned in a border portion between one of two photodiode regions and a first longitudinally elongated diffusion region 518, and a second transfer transistor 512 is positioned in a border portion between the other of the two photodiode regions and the first longitudinally elongated diffusion region 518. In addition, a gate 514, which constitutes a reset transistor 513, is positioned in a first transversely elongated diffusion region 515, which is connected to the first longitudinally elongated diffusion region 518. An amplifying gate 517, which constitutes an amplifying transistor 516, is positioned on a second transversely elongated diffusion region 519, which is located on the opposite side of the first transversely elongated diffusion region 515 regarding one of the photodiode regions is located.

Similarly, in the unit block U2, a longitudinally elongated diffusion region 528 is positioned at one end side between two photodiode regions, the longitudinally elongated diffusion region connected to the two photodiode regions. The first and second transfer transistors 521 and 522 are positioned at each end side of the longitudinally elongated diffusion region. A gate 524, which constitutes a reset transistor 523, is positioned in a first transversely elongated diffusion region 525, which is connected to the longitudinally elongated diffusion region 528. An amplifying gate 527, which constitutes an amplifying transistor 526, is positioned on a second transversely elongated diffusion region 529, which is located on the opposite side of the first transversely elongated diffusion region 525 regarding one of the photodiode regions is located.

Similarly, in the unit block U3, a longitudinally elongated diffusion region 538 is positioned at one end side between two photodiode regions, the longitudinally elongated diffusion region connected to the two photodiode regions. The first and second transfer transistors 531 and 532 are positioned at each end side of the longitudinally elongated diffusion region. A gate 534, which constitutes a reset transistor 533, is positioned in a first transversely elongated diffusion region 535, which is connected to the longitudinally elongated diffusion region 538. An amplifying gate 537, which constitutes an amplifying transistor 536, is positioned on a second transversely elongated diffusion region 539, which is located on the opposite side of the photodiode region by which the first transversely elongated diffusion region 535 regarding one of the photodiode regions is located.

Although it is possible to have a shared structure that includes three or more light receiving sections in one pixel section, a shared structure of a pixel with two or four light receiving sections is suited to obtain operating characteristics enough to maintain optical symmetry, and such a shared structure of a pixel is widely used.

In a layout with such a shared structure of a pixel, the transfer transistors 501 and 502 are formed at a corner of the respective photodiode regions PD1 and PD2, so that the gate regions TX10 and TX20 of the transfer transistors can be formed diagonally to the first direction (column direction) Y. That is, the gate regions TX10 and TX20 can be formed in a manner such that the side edges of the gate regions TX10 and TX20 form a predetermined acute angle with the side edges of the photodiode regions PD1 and PD2.

As described above, the gate region is formed diagonally to the photodiode region, so that the channel width can be maximized. The wider the channel width of the transfer transistor is, the more the transfer efficiency of accumulated signal charges increases.

Preferably, it is advantageous to form the gate region of the transfer transistor in such a manner to make a 45 degree angle to the first direction in order to maximize the channel width.

In addition, the first transfer transistor 501, which corresponds to the first photodiode region PD1, and the second transfer transistor 502, which corresponds to the second photodiode region PD2, share the signal charge storing section FD1. Further, the source region of the reset transistor 503 for resetting the electric potential of the signal charge storing section FD1 is shared by the signal charge storing section FD1, so that FD wirings, namely wirings connected to the signal charge storing section FD1 can be reduced.

Next, layouts of the diffusion region that constitutes the photodiode and transistor as well as the first layer metal wiring connected to the gate electrode will be described with reference to FIG. 2.

First, connections between the first layer metal wiring, and the diffusion region and the gate electrode in the unit block U0 will be described.

The first and second transfer gates are connected to first layer metal wirings 604 and 605, which are located above the transfer gates, via contact holes C4 and C5 respectively. The reset gate 504 is connected to one end of a first layer metal wiring 606 via a contact hole C6. The first layer metal wiring 606 is extended along the side edge of the photodiode region PD2 on the transfer gate side to the opposite side of the reset transistor on the photodiode region PD2. In addition, the drain region of the reset transistor is connected to a first layer metal wiring 607, which is located between two photodiode regions, via a contact hole C7. Further, the signal charge storing section is connected to one end of a first layer metal wiring 601 via a contact hole C1a. The first layer metal wiring 601 is extended along a longitudinal direction so as to partially overhang the amplifying gate 507. The other end of the first layer metal wiring 601 is connected to the amplifying gate 507 via a contact hole C1b. In addition, the source region of the amplifying transistor is connected via the contact hole C2 to a first layer metal wiring 602, which is a signal output line (readout signal line) extended along unit blocks arranged in a longitudinal direction. The drain region of the amplifying transistor is connected via the contact hole C3 to a first layer metal wiring 603, which is a power source line extended along unit blocks arranged in the longitudinal direction.

In the unit blocks U1 to U3, the diffusion region, which constitutes a photodiode and a transistor, as well as the gate electrode are connected to the first layer metal wiring in a similar manner to the unit block U0. That is, in these unit blocks, first layer metal wirings 614, 615, 624, 625, 634, and 635 are respectively connected to transfer gates via respective contact holes. In addition, the first layer metal wirings 614, 615, 624, 625, 634, and 635 are respectively connected to transfer gates via respective contact holes. One end of respective first layer metal wiring 616, 626, and 636 are connected to reset gates via contact holes. The other ends are extended so as to partially overhang the diffusion regions of the amplifying transistor in one of respective adjacent unit blocks. In addition, one end of respective first layer metal wirings 617, 627, and 637 are connected to drain regions of the reset transistors via respective contact holes. Further, one end of respective first layer metal wirings 611, 621 and 631 are connected to the source regions (signal charge storing regions) of reset transistors via respective contact holes. The other ends are extended so as to partially overhang the amplifying gates, and are connected to the amplifying gates via respective contact holes. In addition, the drain of the amplifying transistor in the unit block U1 is connected via a contact hole to the first layer metal wiring 603, which functions as a power source wiring. The drains of the amplifying transistors in the unit blocks U2 and U3 are connected via respective contact holes to a first layer metal wiring 623, which functions as a power source wiring. In addition, the source region of the amplifying transistor in the unit block U1 is connected via a contact hole to a first layer metal wiring 602, which functions as a signal output line. The source regions of the amplifying transistors in the unit blocks U2 and U3 are connected via a contact hole to a first layer metal wiring 622, which functions as a signal output line.

Next, a layout of a second layer metal wiring, which is connected to the first layer metal wiring described above, will be described with reference to FIG. 3.

First, connections between the first layer metal wiring and the second layer metal wiring in the unit block U0 will be described.

Above a plurality of unit blocks, including the unit blocks U0 and U2, arranged in a row direction X (see FIG. 1), there are three parallel, second layer metal wirings 701 to 703 extended over these unit blocks. A second metal layer wiring 702 located at the center of the three wirings is a reset drain line for supplying electric potential to a reset drain. For example, the second metal layer wiring 702 is connected via a contact hole C77 to the first layer metal wiring 607, which is connected to the drain region of the reset transistor in the unit block U0.

Second layer metal wirings 701 and 703, which is located on both sides of the second layer metal wiring 702 described above, are control signal lines (TX control line) of the transfer transistors. For example, each of the second layer metal wirings 701 and 703 is respectively connected via a contact hole C55 to the first layer metal wiring 605, which is connected to the transfer gate TX2 of the unit block U0, and via a contact hole C44 to a first layer metal wiring 604, which is connected to the transfer gate TX1 of the unit block U0.

Further, two parallel, second layer metal wirings 704 and 705 are positioned being extended along the row direction X in one unit block row that is constituted of a plurality of unit blocks arranged in a row direction X (see FIG. 1), and adjacent to another unit block row adjacent to the unit block row. The second layer metal wiring 704 is a power line for supplying power source voltage to the first layer metal wirings 603 and 623, which function as power source wirings extended to the column direction. For example, in the unit block U0, the second layer metal wiring 704 is connected via a contact hole C33 to the first layer metal wiring 603, which functions as a power source wiring. The other, second layer metal wiring 705 is a reset transistor control line. For example, one end of the second layer metal wiring 705 is connected via a contact hole C66 to the other end of the first layer metal wiring 616, which is connected to the reset gate of the unit block U1.

Three parallel, second layer metal wirings 711 to 713 are wirings positioned above a plurality of unit blocks, including the unit blocks U1 and U3, arranged in the row direction X (see FIG. 1). The second layer metal wirings 711 to 713 correspond to the three parallel, second layer metal wirings 701 to 703 arranged above the plurality of unit blocks including the unit blocks U0 and U2. In addition, two parallel, second layer metal wiring 714 and 715 are wirings positioned above the plurality of unit blocks, including the unit blocks U1 and U3, arranged in the row direction X (see FIG. 1). The second layer metal wiring 714 and 715 correspond to the two parallel, second layer metal wirings 704 and 705 arranged above the plurality of unit blocks, including the unit blocks U0 and U2, extended in the row direction X.

Next, a function and effect will be described.

The first layer metal wiring 606 is to be a base for forming the reset transistor control line 705 with a second layer metal wiring. The reset transistor control line controls reset gate voltage to the gate electrode of the reset transistor to reset the electric potential of the signal charge storing section to either a high level or low level.

In addition, electric potential of a drain 505 of the reset transistor 503 is changed to either a high level or low level by selection or non-selection of a pixel. The reset drain line 702 is connected to the reset drain via the first metal wiring 607, which will be a base for forming the reset drain line 702 with the second layer metal wiring.

It is desirable that each metal wiring is wired to avoid covering the photodiode region as much as possible in order to minimize shielding of the photodiode region. That is, it is desirable to wire each metal wiring in a manner such that the exposure of the photodiode region to light will be maximized.

In addition, when the metal wirings cross the photodiode regions, it is desirable for the metal wirings to shield the same amount of area and symmetrical portions in each of the photodiode regions.

Therefore, the first layer metal wiring 606, which is connected to the reset gate, is wired in such a manner to longitudinally cross the PD2 so as to be symmetry with the FD wiring 601 longitudinally.

Thus, according to the present invention, in an amplifying solid-state image capturing apparatus that includes a pixel array having a plurality of pixel sections arranged in a matrix with each pixel section having a 3TR structure, a reset drain wiring is positioned above the pixel array in such a manner to cross the center of each pixel section. Therefore, it is possible to reduce the change in electric potential of a reset drain wiring affecting as noise to an adjacent, selected pixel section connected to another reset drain wiring, and as a result, it is possible to improve S/N ratio.

In addition, according to the layout of the first layer metal wiring shown in FIG. 2, the FD wiring 601 of a selected pixel and the reset drain wiring (first layer metal wiring) 617 connected to a non-selected pixel are distant from each other, and therefore, there is no substantial coupling of capacitance between them.

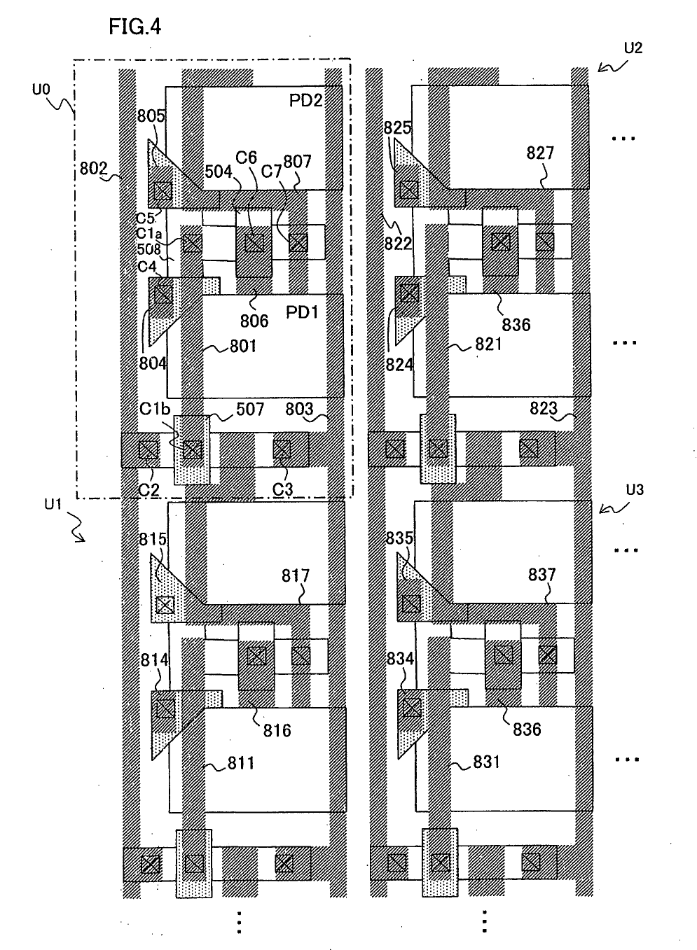

On the other hand, according to the layout of the first layer metal wiring shown in FIG. 4, when the reset drain wiring (first layer metal wiring) 817 is wired, for example, in such a manner to longitudinally cross the photodiode region, a FD wiring 801 of a selected pixel and a reset drain wiring (first layer metal wiring) 817 come close to each other, and there exists the coupling of capacitance between them. As a result, the electric potential of the reset drain wiring fluctuates. This change in the electric potential of the reset drain is transferred as noise to the FD wiring and the noise is output to the signal line. Therefore, the reset drain wiring that becomes the noise source is required to be positioned at the center of the pixel in order to reduce the influence to adjacent pixels. Note that reference numerals in the 800s are used in FIG. 4, the reference numerals correspond to respective reference numerals in the 600s shown in FIG. 2.

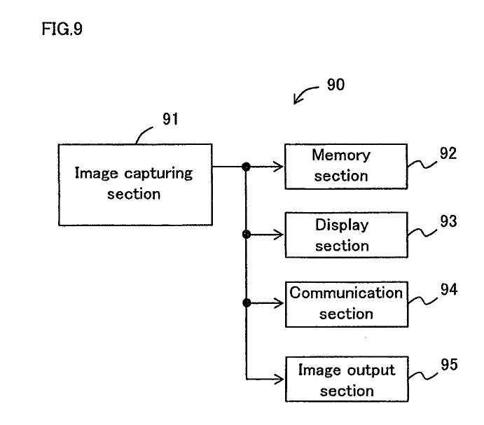

For example, FIG. 8(a) illustrates a state where the change (chain double-dashed line) in electric potential of the selected pixel FD (signal charge storing section of a selected pixel) affects the change (solid line) in electric potential of the readout signal line, and further, the change (solid line) in electric potential of the readout signal line affects electric potential (dotted line) of the non-selected pixel FD (signal charge storing section of the non-selected pixel). Such change in electric potential of the non-selected pixel FD (signal charge section of the non-selected pixel) further causes the change in electric potential of the reset drain wiring that is connected to the non-selected pixel. This will be added to the selected pixel FD (signal charge section of the selected pixel) as noise.

FIG. 8(b) illustrates the change (dotted line) in electric potential of the selected pixel FD when the selected pixel FD (signal charge storing section of the selected pixel) is not affected by such noise as described in the embodiment of the present invention, together as a comparison with the change (solid line) in electric potential of the selected pixel FD when the selected pixel FD (signal charge storing section of the selected pixel) is affected by such noise.

As is understood from FIG. 8(b), when there is a coupling of capacitance between the FD wiring of the selected pixel and the reset drain wiring connected to the non-selected pixel, a small change in electric potential can be observed. However, when there is no coupling of capacitance between the FD wiring of the selected pixel and the reset drain wiring connected to the non-selected pixel, such change in electric potential is not observed.

Further, according to Embodiment 1, the transfer transistor is formed at a corner of each photodiode region. Therefore, the gate region of the transfer transistor can be formed diagonally to a side edge of the rectangular photodiode, and the transferring efficiency of the signal charge can be improved.

Although not specifically described in Embodiment 1, it is needless to say that an insulation film is formed between the substrate and the first layer metal wiring, as well as between the first layer metal wiring and the second layer metal wiring.

### Embodiment 2

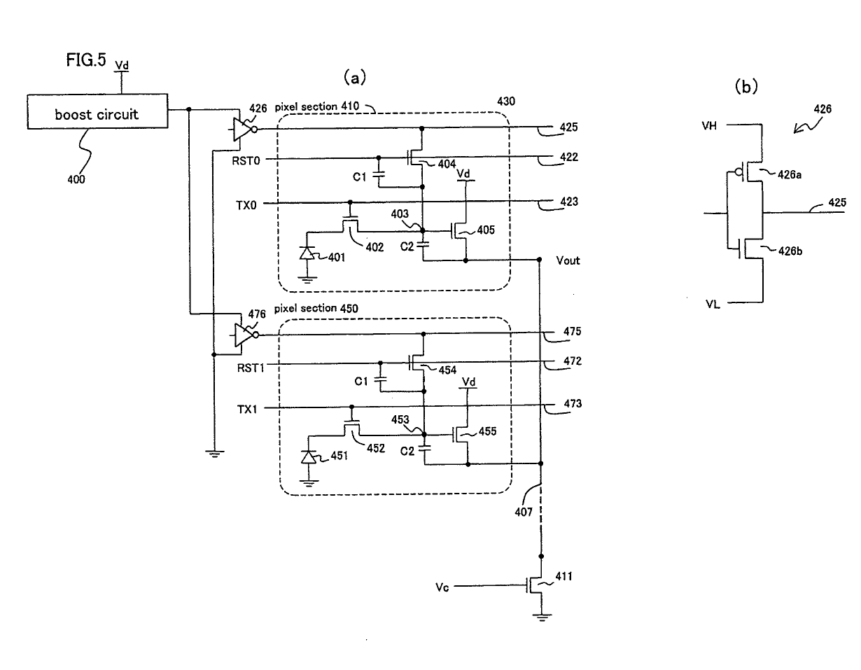

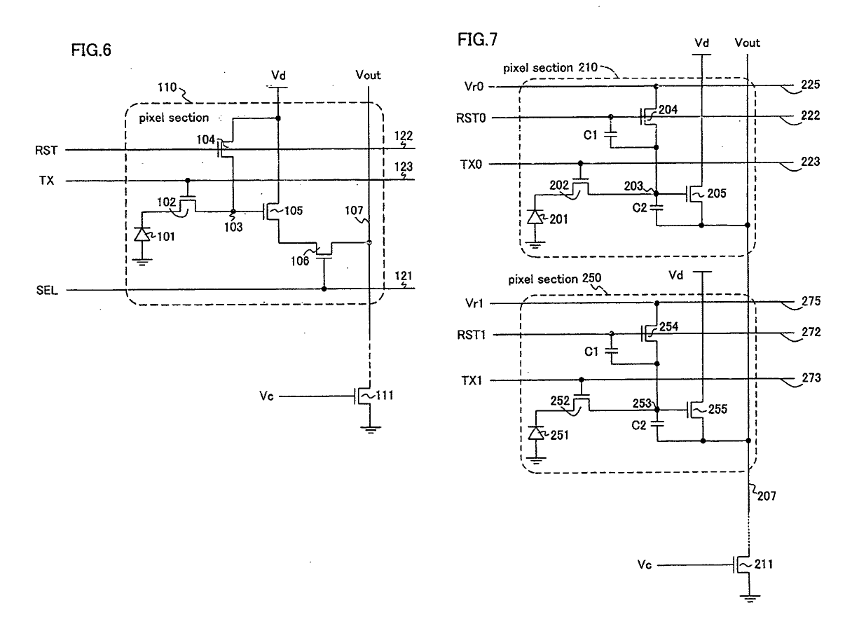

FIG. 5 is a diagram illustrating a three transistor-type solid-state image capturing apparatus according to Embodiment 2 of the present invention, illustrating a circuit configuration of a pixel section that constitutes the solid-state image capturing apparatus.

The solid-state image capturing apparatus according to Embodiment 2 includes, in addition to the circuit configuration of the solid-state image capturing apparatus according to Embodiment 1, a boost circuit for boosting high level voltage to be applied to a reset drain. The layout of a pixel array in the solid-state image capturing apparatus is identical to the layout in Embodiment 1.

That is, the solid-state image capturing apparatus according to Embodiment 2 includes a pixel section array, in which pixel sections are arranged in a matrix, and a boost circuit 400 for boosting power source voltage to drive each pixel section in the pixel section array.

Herein, the boost circuit 400 is constituted of a charge pump circuit and the like, and is for boosting power source voltage Vd to be output.

In addition, the configuration of each pixel section that constitutes the pixel section array is identical to the configuration in Embodiment 1.

That is, a pixel section 410 with a 3TR structure includes a light receiving section 401, which is constituted of a photodiode, a transfer gate transistor 402 for transferring a signal charge generated in the light receiving section 401 to a signal charge storing section 403, a reset transistor 404 connected in between the signal charge storing section 403 and a reset drain wiring 425, and an amplifying transistor 405 connected in between voltage source (power source voltage Vd) and a readout signal line 407.

Herein, a transfer gate wiring 423 is connected to a gate of the transfer transistor 402 described above, and the transfer gate 402 receives a transfer pulse signal TX0 from the transfer gate selection line 423 to transfer a signal charge generated in the light receiving section 401 to the signal charge storing section 403. In addition, a reset signal line 422 is connected to a gate of the reset transistor 404, and the reset transistor 404 applies voltage Vr0 of the reset drain wiring 425 to the signal charge storing section 403 by a reset signal RST0 from the reset signal line 422.

In addition, a pixel section 450 with a 3TR structure is formed of a photodiode in a similar manner to the pixel section 410 with a 3TR structure. The pixel section 450 is constituted of a light receiving section 451 for generating a signal charge by photoelectric conversion, a transfer gate transistor 452 for transferring the signal charge to a signal charge storing section 453 based on a transfer pulse signal TX1 from a transfer gate selection line 473, a reset transistor 454 for applying voltage Vr1 of a reset drain wiring 475 to the signal charge storing section 453 based on a reset signal RST1 from a reset signal line 472, and an amplifying transistor 455 for amplifying signal voltage generated in the signal charge storing section 453 or reset voltage to output the signal voltage or the reset voltage to the readout signal line 407.

The pixel section 410 and pixel section 450 are connected to the readout signal line 407 together with other pixel sections in the same column, and the readout signal line 407 is connected to a constant current source load 411. The constant current source load 411 is constituted of a transistor connected between one end of the readout signal line 407 and a ground, and agate voltage of the transistor is set to a constant voltage Vc.

In addition, a buffer for setting electric potential of the reset drain wiring is connected for each row in each pixel section. For example, a buffer 426 is connected to the reset drain wiring 425, and a buffer 476 is connected to the reset drain wiring 475.

Herein, the buffer 426 is constituted of a CMOS inverter, which is constituted of a P-type MOS transistor 426a and an N-type MOS transistor 426b that are connected in series between a high level electric potential VH, which is an output of the boost circuit 400 described above, and the low level electric potential VL, which is higher than 0V. A common gate of the two transistors is connected to a control signal of the reset drain wiring, and a common connection point of the two transistors is connected to the reset drain wiring 425.

In the solid-state image capturing apparatus according to Embodiment 2, which has such a configuration, the high level electric potential applied to the reset drain wiring is boosted by the power source voltage. Therefore, the transferring efficiency of the signal charge from the light receiving section to the signal charge storing section can be improved. In addition, the low level electric potential applied to the reset drain wiring is higher than 0V. Therefore, the back flow of the signal charge can be prevented from the charge storing section.

### Embodiment 3

Although not specifically described in Embodiment 1 or 2 described above, an electronic information device will be described herein after. The electronic information device, such as a digital camera (e.g., digital video camera and digital still camera), an image input camera, a scanner, a facsimile machine and a camera-equipped cell phone device, has at least one of the solid-state image capturing apparatuses according to Embodiments 1 and 2 described above as an image input device in an image capturing section.

FIG. 9 is a block diagram illustrating an exemplary diagrammatic structure of an electronic information device using a solid-state image capturing apparatus of any of Embodiments 1 and 2 in an image capturing section, as Embodiment 3 of the present invention.

The electronic information device 90 according to Embodiment 3 of the present invention shown in FIG. 9 includes an image capturing section 91 using at least either of the solid-state image capturing apparatuses according to Embodiments 1 and 2, and further using at least any of: a memory section 92 (e.g., recording media) for data-recording a high-quality image data obtained by the image capturing section after a predetermined signal process is performed on the image data for recording; a display section 93 (e.g., liquid crystal display device) for displaying this image data on a display screen (e.g., liquid crystal display screen) after a predetermined signal process is performed for display; a communication section 94 (e.g., transmitting and receiving device) for communicating this image data after a predetermined signal process is performed on the image data for communication; and an image output section 95 for printing (typing out) and outputting (printing out) this image data.

As described above, the present invention is exemplified by the use of its preferred Embodiments 1 to 3. However, the present invention should not be interpreted solely based on Embodiments 1 to 3 described above. It is understood that the scope of the present invention should be interpreted solely based on the claims. It is also understood that those skilled in the art can implement equivalent scope of technology, based on the description of the present invention and common knowledge from the description of the detailed preferred Embodiments 1 to 3 of the present invention. Furthermore, it is understood that any patent, any patent application and any references cited in the present specification should be incorporated by reference in the present specification in the same manner as the contents are specifically described therein.

### INDUSTRIAL APPLICABILITY

The present invention can be applied in the field of a solid-state image capturing apparatus, and an electronic information device, such as a digital still camera, a digital movie camera and a camera-equipped cell phone device, using the solid-state image capturing apparatus in the image capturing section. According to the present invention, on a pixel array having a plurality of pixel sections arranged in a matrix, a reset drain wiring is positioned above the pixel array in such a manner to cross the center of each pixel section. Therefore, it is possible to reduce the change in electric potential of a reset drain wiring affecting as noise to an adjacent, selected pixel section connected to another reset drain wiring, and as a result, it is possible to improve S/N ratio.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. A solid-state image capturing apparatus, comprising a pixel array in which pixel sections for outputting a pixel signal in accordance with incident light are arranged in two dimensions, and a readout signal line arranged for each pixel section column on the pixel array, for reading out a pixel signal from each pixel section in each pixel section column,
wherein each pixel section includes:
a light receiving section for performing photoelectric conversion on the incident light;
a signal charge storing section for storing a signal charge generated in the light receiving section and generating electric potential in accordance with the stored signal charge; and
a reset transistor for resetting the electric potential of the signal charge storing section to reset electric potential,
wherein a reset drain wiring for supplying the reset electric potential to a drain of the reset transistor being positioned above a plurality of pixel sections in the pixel array in such a manner to cross the center of each pixel section.

2. A solid-state image capturing apparatus according to claim 1, wherein a wiring layer, which constitutes the reset drain wiring, is formed by a second layer metal wiring of multiple layer wirings that are laminated with alternately interposed insulation films on the pixel array, and is connected to a drain region in the drain region of the reset transistor via a first layer metal wiring formed on the pixel array.

3. A solid-state image capturing apparatus according to claim 2, wherein the first layer metal wiring, which connects the drain region and the reset drain wiring constituted of the second layer metal wiring, in the drain region of the reset transistor is positioned only in the drain region so as to be located at the center of the pixel section.

4. A solid-state image capturing apparatus according to claim 1, wherein the light receiving section is constituted of two photodiodes positioned in an opposing manner on both sides of the signal charge storing section.

5. A solid-state image capturing apparatus according to claim 4, wherein the pixel section includes two transfer transistors for transferring the signal charge from each photodiode to the signal charge storing section, the two transfer transistors corresponding to the two photodiodes.

6. A solid-state image capturing apparatus according to claim 5, wherein the photodiode is an embedded photodiode.

7. A solid-state image capturing apparatus according to claim 5,
wherein two diffusion regions, which constitute each of the photodiodes, are connected to a diffusion region, which is located in between the two diffusion regions and constitutes the signal charge storing section, and
wherein a gate electrode of each of the transfer transistors is positioned above a connecting portion between a diffusion region constituting the photodiode and a diffusion region constituting the signal charge storing section.

8. A solid-state image capturing apparatus according to claim 7, wherein:
the diffusion region constituting the photodiode is a rectangle;
the diffusion region constituting the signal charge storing section is a longitudinally elongated rectangle;
the gate electrode of each of the transfer transistors is positioned at a corner of the rectangular diffusion region that constitutes the photodiode, and is positioned diagonally to a side edge of the rectangle.

9. A solid-state image capturing apparatus according to claim 4, wherein the reset drain wiring is positioned in between two opposing photodiodes that constitute the pixel section.

10. A solid-state image capturing apparatus according to claim 5, wherein the pixel section includes one amplifying transistor for amplifying electric potential of the signal charge storing section to read out the electric potential to the readout signal line.

11. A solid-state image capturing apparatus according to claim 1, wherein a first voltage is applied to the reset drain wiring when the pixel section connected to the reset drain wiring is selected, and a second voltage is applied to the reset drain wiring when the pixel section connected to the reset drain is not selected, the first voltage being higher than or equal to the second voltage.

12. A solid-state image capturing apparatus according to claim 11, wherein the first voltage is higher than or equal to power source voltage, and the second voltage is higher than or equal to 0V.

13. A solid-state image capturing apparatus according to claim 1, wherein the light receiving section, which constitutes the pixel section, is constituted of a plurality of photoelectric conversion elements.

14. A solid-state image capturing apparatus according to claim 13, wherein the light receiving section, which constitutes the pixel section, is constituted of two or four photoelectric conversion elements.

15. A solid-state image capturing apparatus according to claim 1, wherein the solid-state image capturing apparatus includes a buffer circuit for applying the first voltage or the second voltage to the reset drain wiring.

16. A solid-state image capturing apparatus according to claim 15, wherein the buffer circuit is constituted of a CMOS inverter, which is constituted of a P-type MOS transistor and an N-type MOS transistor that are connected in series between a node, to which the first voltage is supplied, and a node, to which the second voltage is supplied.

17. A solid-state image capturing apparatus according to claim 15, further including a boost circuit for boosting the first voltage supplied to the buffer circuit more than power source voltage.

18. An electronic information device comprising an image capturing section, in which the solid-state image capturing apparatus according to claim 1 is used for the image capturing section.
